(19) United States
(12) Patent Application Publication
(10) Pub. No.: US 2017/0107001 A1
(43) Pub. Date: Apr. 20, 2017

(54) AIRCRAFT LANDING EMERGENCY CARRIAGE

(71) Applicant: Robert Barnes, Woodridge (AU)

(72) Inventor: Robert Barnes, Woodridge (AU)

(21) Appl. No.: 15/128,107

(22) PCT Filed: Mar. 23, 2015
(86) PCT No.: PCT/AU2015/000167

§ 371 Date: Sep. 22, 2016

(30) Foreign Application Priority Data
Mar. 23, 2014 (AU) 2014901019

(51) Int. Cl. B64F 1/22; B64F 1/02

(52) U.S. Cl. CPC B64F 1/22; B64F 1/02

(57) ABSTRACT

A method of landing an aircraft which is overweight or whose landing wheels are not operatively deployed, including: providing a carriage assembly which may travel along a landing path at the landing speed of the aircraft; providing braking means capable of decelerating the carriage assembly supporting an aircraft to a manoeuvrable speed within the length of the landing strip; operatively positioning the carriage assembly for receiving an aircraft at the end of its flight path; flying the aircraft onto the operatively positioned carriage assembly; and operating the braking means to reduce the speed of the carriage assembly supporting the aircraft.

This invention relates to an aircraft landing emergency carriage and to methods of landing aircraft which are overweight or whose landing wheels are inoperative and to emergency landing means for landing aircraft.

Aircraft whose overall landing weight exceeds the maximum allowable for that type are vulnerable unless they reduce their weight by burning off or dumping fuel until the aircraft reaches its safe landing weight. Should an emergency situation such as an on board fire arise whilst the aircraft is still overweight the possibility of a catastrophic accident is extremely likely.

Aircraft whose landing wheels have not operatively deployed generally results in damage to the aircraft and or the landing field. Where the aircraft is a large passenger aircraft such an emergency landing not only risks the lives of the passengers and crew of the aircraft but also those of the airport personnel directly involved with the emergency landing. In addition an emergency wheels-up landing at a busy airport can severely disrupt the normal operations of the airport and the costs associated with such an emergency landing, including the cost of diverting following aircraft which can be very high.

This invention aims to provide methods of landing aircraft whose landing wheels are inoperative. This invention also aims to provide landing means which will enable an aircraft which does not have an operable undercarriage to land safely and without causing significant damage to the airfield or aircraft. Other aims of this invention will become apparent from the following description.

With the foregoing in view, this invention in one aspect resides broadly in a method of landing an aircraft whose landing wheels are not operatively deployed, including:

providing a carriage assembly which may travel along a landing path at the landing speed of the aircraft;

providing braking means capable of decelerating the carriage assembly supporting an aircraft to a manoeuvrable speed within the length of the landing strip;

operatively positioning the carriage assembly for receiving an aircraft at the end of its flight path;

flying the aircraft onto the operatively positioned carriage assembly; and

operating the braking means to reduce the speed of the carriage assembly supporting the aircraft.

The speed reduction may be to a standstill within the length of the landing path or it may be to a taxiing speed.

The landing path may be a regularly used landing strip or runway at an airport or it may be a dedicated emergency landing path which may be adjacent to or remote from a regularly used airport. Preferably however the landing strip or runway is a regularly used runway at an airport where all necessary landing, control and emergency services are active. It is also preferred that the carriage assembly be parked ready for use adjacent the runway and preferably beside the runway at a central location on or in-line with the runway, from which parked position the carriage assembly may be readily moved to the touchdown zone of the aircraft to receive the landing aircraft. The carriage assembly may be moved to its aligned position with the runway on its own wheels. The carriage assembly may be parked in an underground building from which it may be moved up an incline to the runway or from which it may be raised vertically to the level of the runway or it may be parked in a position which does not lie in the flight path of landing aircraft.

Preferably the carriage assembly receives the aircraft in its nose-up landing position at an altitude above its touchdown altitude whereby the aircraft may be united with the carriage assembly at a position close to the start of the runway, leaving most of the runway available for the united aircraft and carriage assembly to be individually controlled to achieve correct positioning relative to one another and to the runway for ultimate total support and control of the aircraft by the carriage assembly before the end of the runway.

The carriage assembly suitably includes aircraft capture means to operatively unite the landed aircraft with the carriage assembly whereby upon landing, the aircraft and the carriage assembly travel along the runway as a combined unit which may be controlled by controlling the carriage assembly. Of course during travel of the combined unit, any control assistance available to the aircraft pilot, for lateral, vertical or rotational control, may be utilised to assist a safe conclusion for the landing. For example, the pilot or autopilot may utilise the aircraft's normal flight controls upon uniting with the carriage assembly to assist in the direction of travel along the runway or to bring the wings of the aircraft level with one another or adjust the trim of the captured aircraft. Preferably however, after capture, alignment is done solely by the carriage assembly, as aircraft's directional input could cause instability.

The pilot or autopilot may also utilise the aircraft's reverse thrust and or air braking to assist in bringing the combined unit to a safe taxiing speed or to a standstill before the end of the runway. The brakes of the carriage assembly may incorporate automated antilock braking for effective maximum braking in varying weather conditions.

The capture means may include symmetrically disposed and laterally spaced apart jaws on the carriage assembly which engage the aircraft to cause or assist deceleration of the carriage assembly to the speed of the aircraft. Preferably the jaws engage the aircraft between the locations of the front and main undercarriages and forward of the aircraft's leading edges. The capture means may also include fence means for preventing passage of the aircraft past the carriage assembly. The jaws may move or they may include expandable components to capture the aircraft fuselage.

Preferably the capture means is able to capture and hold the aircraft in its landing attitude whereafter the aircraft may be tilted with the capture means to a level disembarking attitude. This may occur during travel down the runway of the combined unit or it may occur after the combined unit has been brought to taxiing speed or a standstill. For this purpose the carriage assembly may be provided with jacking means for tilting the carriage assembly to level the landed aircraft during travel of the combined unit along the runway.

Preferably however, the capture means includes an elevated cradle assembly which may be raised and lowered relative to the runway on which the carriage assembly is positioned and onto which the aircraft touches down. Subsequently and preferably during travel down the runway, the elevated cradle assembly is lowered and rotated to lower the aircraft to a level attitude. This action lowers the centre of gravity of the aircraft which assists stability of the combined unit and it occurs whilst the aircraft's flight surfaces may be utilised to assist stability of the combined unit and/or reduce the load on the cradle assembly and or its supports. Any such control of the aircraft's flight surfaces may be performed by the pilot or by an autopilot suitably communicating with the controls of the carriage assembly.

The cradle assembly suitably includes form conforming supports able to cradle the aircraft fuselage without causing significant point loading which could damage the aircraft and endanger the people in the aircraft. The form conforming supports also act to cushion the impact of the aircraft with the carriage assembly. Preferably the cradle assembly is positioned so as to support the aircraft intermediate its nose wheels and its main undercarriage and forward of the aircraft's leading edges and suitably the carriage assembly is of such length that it may be pivotally supported for movement from an elevated position inclined at a capture angle substantially corresponding to the flight angle of the aircraft at the end of its flight path and a lower substantially level disembarking attitude.

The cradle means and the capture means may be integrated into a central fuselage receiving assembly having opposed side parts which are separated when the receiving assembly is in an elevated position to form the capture means and which side parts move toward one another when lowered so as to encompass a portion of the aircraft fuselage and preferably a portion of the fuselage between the nose wheel and the main undercarriage.

In a preferred method of landing an aircraft according to this invention, drive means are provided for accelerating the carriage assembly to the landing speed of the aircraft and preferably the drive means is sufficiently powerful to accelerate the carriage assembly to the landing speed in one third to one half the length of the runway so that sufficient runway remains after the aircraft lands on the carriage assembly to brake the combined unit to a standstill. Once the aircraft is captured, suitably within one-half the length of the runway, the combined braking of the carriage assembly wheels, reverse thrust from the aircraft engines and application of the aircrafts air brakes, will enable the combined unit to stop in a significantly shorter distance than would be required for a conventional landing.

Suitably the drive means for the carriage assembly is remotely operable to control the speed of the carriage assembly which may be substantially the same as or slower than the speed of the landing aircraft at the point of touchdown. The speed of the carriage assembly may be achieved by accelerating the carriage assembly along the runway beneath the landing aircraft substantially to its touchdown speed and then controlling the speed of the carriage assembly by providing monitoring means for monitoring the speed and position of the landing aircraft relative to the carriage assembly for controlling the speed and/or direction of the carriage assembly accordingly to achieve operative engagement of the aircraft with the carriage assembly.

The drive means for accelerating the carriage assembly to the landing speed of the aircraft may be provided by on-board power means or by remote power means such as a fixed winch or sling assembly connected to the carriage assembly by suitable cable(s) which may be a pair of cables disposed at opposite side of the runway and/or a central cable which may be supported in a recess in the runway when not in use. The use of a winch and/or sling assembly has the advantage of minimising the weight of the carriage assembly whereas the use of on-board drive means has the advantage of causing minimum disruption to an existing landing strip.

The carriage assembly may include a base frame having sets of drive wheels arranged along opposite sides thereof and centrally disposed wheels if desired. The drive wheels may also be provided with braking means which may be separate friction brakes or the like or the braking means may be provided by a reverse operation of their drive means. The transport wheels are also suitably provided with suspension means to absorb the shock loads imposed on the carriage assembly during the initial landing of the aircraft on the carriage assembly.

In addition to the transport wheels, the cradle assembly may have a normally elevated cradle undercarriage for supporting the landing loads of the captured aircraft and which engages the landing strip only when the cradle assembly is lowered. This arrangement minimises the power of the drive means required to accelerate the carriage assembly to a landing speed as the wheels of the cradle undercarriage do not have to be accelerated up to the landing speed by the drive means. These undercarriage wheels may also incorporate brakes for assisting in decelerating the aircraft during travel down the runway.

Most passenger airliners land with a significant nose-up attitude of about 5° and at a speed in the order of 220 kph (120 knots). These airliners are monitored and directed by air traffic control for landing in the first third of the airstrip leaving one half to two thirds of the runway for braking to a taxiing speed.

According to one aspect of this invention the carriage assembly is adapted for remote control by a dedicated controller. The control of the drive means, the braking means and the attitude and/or the position of the cradle assembly on the carriage assembly is preferably performed automatically and suitably by utilising computer aided control associated with an information base such as air traffic control which has access to details and dynamics of the aircraft, its loading and its emergency condition and the like. This information would enable accurate calculation of the desired capture location and routine for effective positioning of the carriage assembly relative to the aircraft to achieve a safe outcome for the emergency landing and braking to a desired speed which may be zero kph or a taxiing speed. Thereafter, the aircraft pilot, the dedicated controller or air traffic control or other ground personnel are able to assume control of the combined unit and taxi it to a disembarking station. For this purpose, some of the carriage wheels may be steerable to assist in the directional control of the combined unit. Preferably for steering the combined unit down a runway after capture of an aircraft only the front wheels are steered.

This method is preferred as the pilot or autopilot can perform a normal landing without regard to the position of the carriage assembly which will be positioned automatically to capture the aircraft for a safe landing.

In another aspect this invention resides broadly in a carriage assembly for use in at least one of the methods described above, and including:

a carriage assembly for capturing a landing aircraft at touchdown, and

braking means for decelerating the carriage assembly and a captured aircraft to a manoeuvrable speed within the length of the landing strip.

Preferably the carriage assembly is provided with drive means for operatively positioning the carriage assembly on the runway for receiving an aircraft at the end of its flight path and preferably for accelerating the carriage assembly to the landing speed of the aircraft to be captured and more preferably for accelerating the carriage assembly to the landing speed before receiving the aircraft.

In one embodiment of the invention the carriage assembly includes a base assembly supporting a cradle assembly which may receive an aircraft at an altitude above its normal landing altitude relative to the runway and subsequently capture the aircraft after which the cradle assembly is lowered with the aircraft. At no point does the aircraft landing gear come into contact with or rest upon the carriage assembly.

Suitably the base assembly is provided with opposed sets of carriage wheels which are capable of supporting the landing aircraft and suitably each wheel or wheel set is provided with suspension means for cushioning any impact of the landing aircraft on the carriage assembly. The carriage wheels may be driven by electric motors powered from a battery bank on the carriage assembly and/or a generator supported on the carriage assembly. The carriage wheels or wheel sets may be driven by individual electric motors and each carriage wheel may be provided with braking means, preferably incorporating an antilock system, so as to provide maximum braking potential for the carriage assembly. The carriage assembly may also be provided with jet engines or rockets to assist or cause acceleration of the carriage assembly to the aircraft's landing speed.

In one form of the invention, the cradle assembly is pivotally attached to the base assembly adjacent the rear end of the base assembly whereby the attitude of the cradle assembly when elevated substantially corresponds to the nose-up attitude of a landing aircraft. The cradle assembly may be a U-shaped support provided with suitable cushioning means for conforming to the fuselage shape of aircraft proposed to utilise the carriage assembly. In a preferred form the cradle assembly has a pair of opposed jaw assemblies which open and close from a base pivot assembly whereby the upper end portions of the jaw assemblies are spaced apart when elevated to provide a wide entrance for receiving an aircraft fuselage and which may be closed on capturing an aircraft fuselage therebetween.

The cradle assembly may be provided with selectively operable closure means for operatively closing the jaw assemblies independently of the position of the cradle assembly or the jaws may be independently pivotally connected to the base assembly or provided with a control linkage whereby they move toward one another as they are lowered and opened when raised. The cradle assembly may also be provided with air bags which may be selectively or automatically actuated by impact to engage about the captured fuselage. Air bags or other forms of jacking/lowering means may be utilised to raise and lower the cradle assembly from and to the base assembly.

Preferably the cradle assembly is provided with an undercarriage assembly similar to the aircraft's main undercarriage which may be positioned medially of the jaw assemblies and be elevated above the ground when the cradle assembly is elevated and adapted to engage the ground only as the cradle assembly approaches its lowered position. Upon ground engagement the cradle assembly undercarriage landing loads will be transferred into the nose section of the aircraft between its main undercarriage and its nose wheel with the aim of minimising abnormal stresses applied to the aircraft structure.

Preferably the carriage assembly incorporates monitoring means which may include cameras or other detection means to enable automated control of the carriage assembly and/or aircraft for receiving, capturing and braking the carriage assembly and/or the aircraft. The monitoring means may also enable an on-ground operator to monitor the landing sequence and provide overriding control input if necessary.

In order that this invention may be more readily understood and put into practical effect, reference will now be made to the accompanying drawings which illustrate an embodiment of this invention, and wherein:

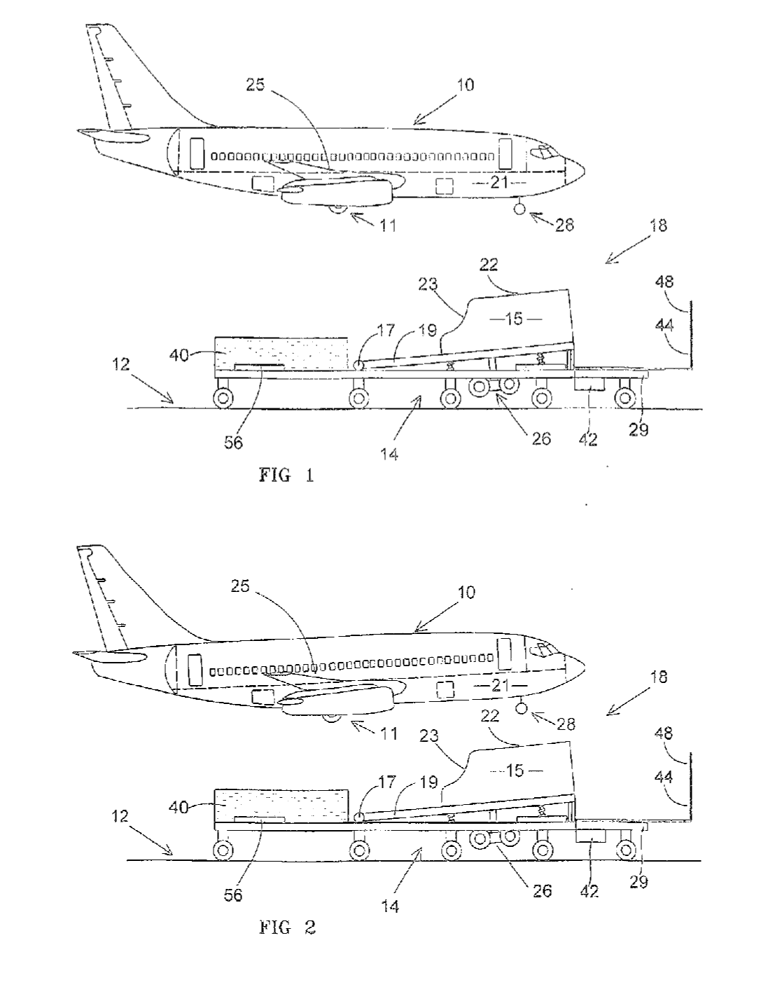

FIGS. 1 and 2 are sequential side views illustrating the relative positioning between a landing aircraft and a carriage assembly moving along a runway;

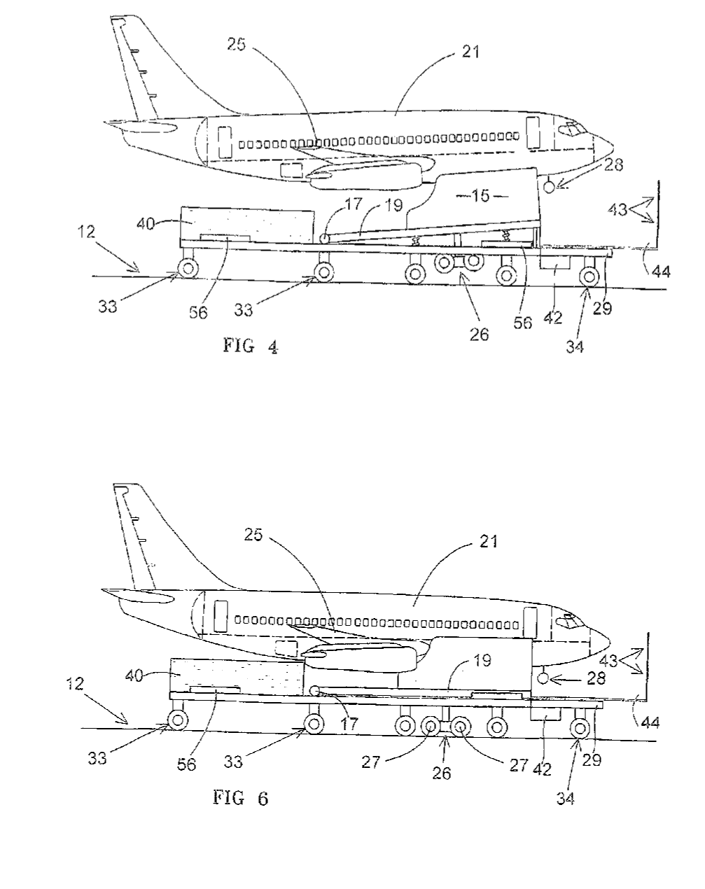

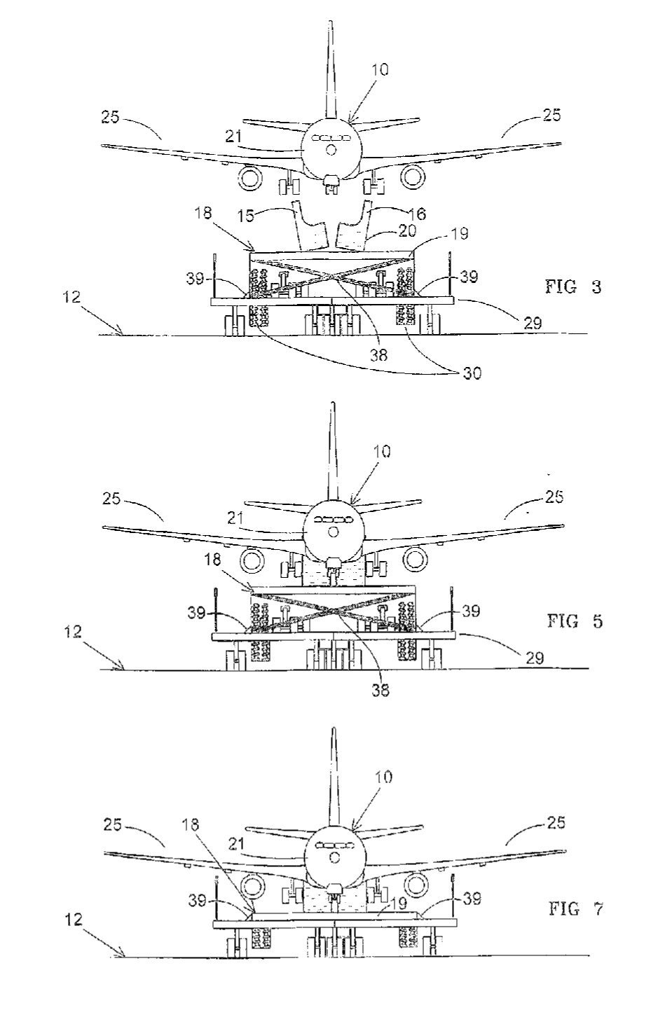

FIG. 3 is a front view of the aircraft and carriage assembly at a later stage in the landing sequence;

FIG. 4 is a side view illustrating a later stage of the landing sequence in which the aircraft is captured by the carriage assembly;

FIG. 5 is a front view corresponding to FIG. 4;

FIG. 6 is a side view illustrating the captured aircraft captured supported by the carriage assembly;

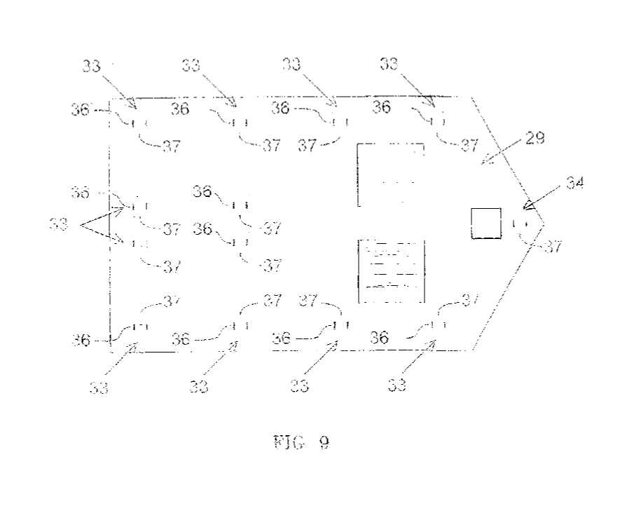

FIG. 7 is a front view corresponding to FIG. 6;

FIG. 8 is a plan view corresponding to FIG. 6

FIG. 9 is a plan view illustrating the undercarriage arrangement of the carriage assembly;

FIGS. 10, 11 and 12 are side views illustrating further versions of the carriage assembly, and

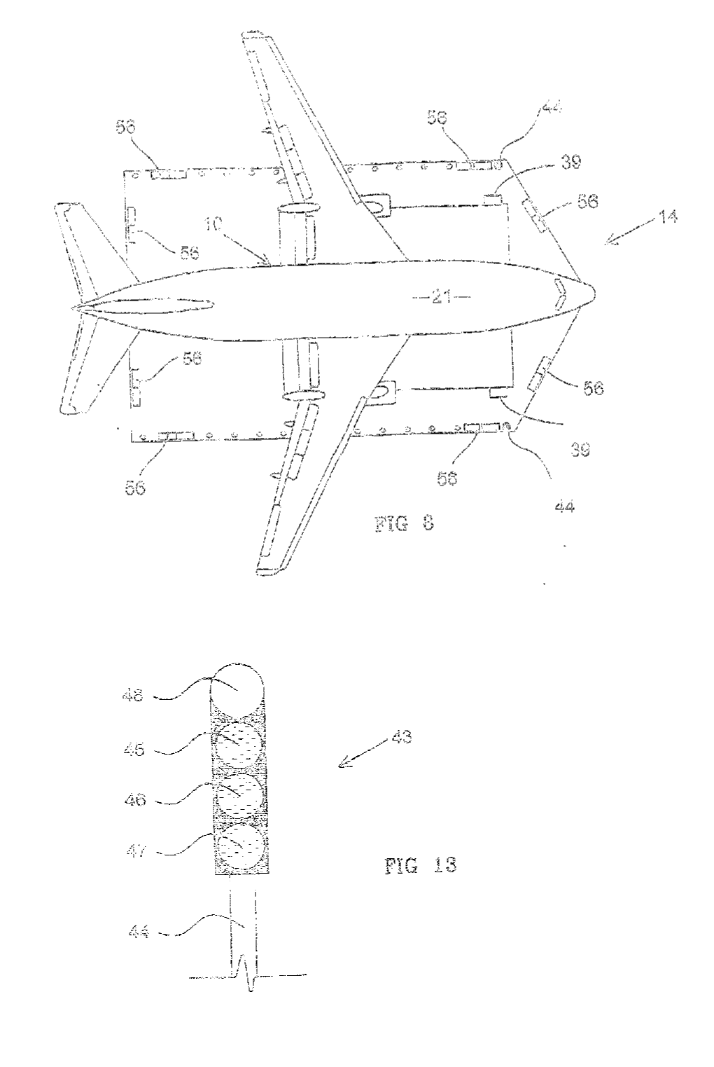

FIG. 13 is a diagrammatic illustration of one form of light tower.

FIG. 1 illustrates an aircraft 10, whose main undercarriage assembly 11 has not operatively deployed, making a normal approach for a landing on a runway 12. As the aircraft 10 approaches the start of the runway and descends it is guided by an autopilot which has been suitably programmed for the emergency landing on the carriage assembly, remote operators and/or the pilots. At the same time a remotely controlled carriage assembly 14 made in accordance with one aspect of this invention, which had been positioned at the start of the runway, reacts to control signals whereby the carriage assembly 14 is timely accelerated down the runway 12 to a speed approximately the same as the speed of the landing aircraft 10 so as to be in an aircraft receiving position beneath the aircraft 10, such as is illustrated in FIGS. 2 and 3.

The carriage assembly 14 is remotely controlled utilising, inter alia, inputs from sensing means on the carriage assembly 14 which monitors the position of the aircraft 10 relative to the carriage assembly 14. As the carriage assembly 14 travels down the runway 12 it receives speed and/or directional control inputs calculated to operatively maintain the carriage assembly 14 in an aircraft receiving position for receiving the aircraft 10 between the open jaws 15 and 16 of an elevated cradle assembly 18, which is pivotally attached at 17, through its base frame 19 to the rear of the carriage assembly 14. When elevated, the cradle assembly 14 inclines upwardly, as illustrated in FIGS. 1, 2 and 4, to receive a landing aircraft which has been rotated to a nose-up landing attitude, as illustrated in FIG. 2, as for a normal landing.

At a height of about six metres above the runway the rotated aircraft 10 is received between the open jaws 15 and 16 which are pivotally attached along their outer edges 20 to a base frame 19 whereby the inner portions thereof are elevated when the jaws are open so that the jaws 15, 16 pivot inwards under the weight of the aircraft 10 received therebetween to close about the aircraft fuselage 21 at a location between the main undercarriage assembly 11 and the nose wheel assembly 28 and capture the aircraft 10 at or around its centre of gravity. The combined unit consisting of the aircraft 10 and the carriage assembly 14 then travels along the runway for controlled descent of the aircraft 10 to a level disembarking attitude and for braking to a taxiing speed before the end of the runway. The mechanism causing the controlled descent may also be associated with the jaws 15, 16 so as to ensure that a locking pressure is maintained against the aircraft fuselage.

In this embodiment the jaws 15 and 16 are lined with high-density foam so that as the underside of the fuselage 21 loads the inner jaw portions, the foam collapses and/or deforms to conform to the shape of the captured fuselage 21. This conforming action minimises damage to the fuselage 21 of the captured aircraft 10.

Each jaw assembly 15, 16 has an elongate leading portion 22 which engages about the fuselage 21 ahead of the aircraft's wings 25 and a scalloped rear portion 23 which is shaped to maintain clearance about the aircraft's wings 25 as these often contain fuel tanks which desirably remain intact in a successful emergency landing.

Control of the carriage assembly 14 and thus the capture position of the jaws 15, 16 relative to the aircraft 10 is assisted by ongoing computer calculations during the aircraft's approach to the carriage assembly 14. Because the carriage assembly is unmanned, it is controlled remotely by control means which receives inputs from the carriage assembly 14 and landing aircraft 10 and if desired, further input from a database of information regarding landing weights and performance of different aircraft and other relevant information.

The cradle assembly 18 is also provided with an undercarriage 26 having, in this embodiment, two sets of dual 4×4 aircraft type landing wheel assemblies which are supported beneath the jaws 15 and 16 by the base frame 19. The undercarriage 26 is normally elevated above the runway 12 and engages the runway 12 only after the cradle assembly 18 pivots to a lower position. This pivoting action simultaneously pivots the captured aircraft 10 to a level disembarking attitude.

In this embodiment, the cradle assembly 18 is supported in its elevated attitude by spring/shock absorber units 30 which, together with the jaws 15, 16 absorb the initial impact of the aircraft with the cradle assembly 18. These units 30 compress as the aircraft load imposed thereon is increased and cause the cradle assembly 18 to pivot to its lower position supported by the carriage frame 29 and the undercarriage 26. The wheels 27 of the undercarriage 26 are braked wheels whereby the brakes may be applied to assist in slowing the aircraft as it travels on the carriage assembly 14 along the runway 12 in a lowered level attitude. This configuration provides landing and braking forces applied to the aircraft between its main undercarriage 11 and its nose wheel assembly 28 so as to maintain the dynamics of the landing loads applied to the aircraft similar to those applied during a normal landing.

As illustrated in plan view in FIG. 9, the carriage frame 29 has four sets of wheel assemblies 33 along each side and additional sets of wheel assemblies 34 and 35 at the front and back of the carriage assembly 14 on which it travels along the runway and which at least partially support the captured aircraft. These wheel assemblies 33, 34 and 35 are of the same general type as an aircraft's dual undercarriage which are provided with suspension means for absorbing the initial aircraft landing loads. In addition, each dual wheel assembly is provided with a remotely controlled electric drive motor 36 and brake assembly 37.

As illustrated in FIGS. 3 and 5, the front of the cradle assembly 18 is also provided with a scissors type support 38 which provides lateral stability to the pivotally supported cradle assembly 18 during the capture and lowering sequence and catches 39 are provided to lock the cradle assembly 18 to the carriage frame 29 upon the cradle assembly 18 pivoting to its lowered attitude on the carriage frame 29.

After the aircraft is captured and lowered, the brakes 37 on all the ground engaging wheel assemblies 27, 33, 34 and 35 are applied to reduce the speed of the combined unit to a safe taxiing speed or to a standstill on the runway 12 to enable the passengers to disembark from the aircraft. Braking may also be assisted by application of reverse thrust and/or the application of the air brakes of the captured aircraft 10.

It will be appreciated that due to the increase in the height of the captured aircraft 10 above the ground level 12 when on the carriage assembly 14, the aircraft's emergency slides will have insufficient length to reach the ground. In the event that an emergency evacuation of the aircraft 10 is required, the cabin crew will first deploy the emergency slides on the aircraft 10 then the emergency slides 56 on the carriage assembly 14 so as to facilitate rapid evacuation.

It will also be seen that the carriage frame 29 supports a cushioning block 40 at its rear end to provide support to the tail end of the aircraft 10 if necessary and that the battery pack or generating set for supplying electricity to the electric motors for driving the wheel assemblies 27, 33, 34 and 35 is positioned in an engine bay 42 at the front of the carriage assembly 14 behind the front wheel assembly 34.

The carriage assembly 14 is also provided with capture sequence indicator means 43 supported on masts 44 mounted at the front and at each side of the carriage assembly 14 whereby they are visible to the aircraft's pilot for indicating the current state of the capture sequence. These indicate when the pilot may make adjustments to the landing procedure of the aircraft to achieve correct landing operations for capture and landing on the carriage assembly 14. The masts are formed to collapse and pivot to a stowed position as illustrated in FIG. 8 from which they may be moved to an operative forward position, as shown in FIG. 1 where they remain visible to the aircraft's pilot. The masts fold for storage.

The indicator means 43, as illustrated in FIG. 13 may be a set of vertically separated different coloured lights which are visible from all around and which illuminate individually to indicate a condition of the capture sequence. This provides a simple visual indication to the pilot and/or the carriage controllers of the landing sequence such that manual override correction can be made quickly if necessary from the pilot or remote control personnel, who may be in the control tower or in a vehicle travelling alongside the carriage assembly 14.

The lights 43 in this embodiment include a red top light 45, which indicates when operative alignment between the aircraft 10 and the carriage assembly 14 has been achieved, alerting the pilot to rotate the aircraft and bring it into the jaws 15, 16 for capture of the aircraft 10, an intermediate orange light 46 indicating that capture has been effected and a lower green light 47 indicating a lowered captured and locked condition in which the pilot may apply reverse thrust and or air braking where available to assist with braking the aircraft to a stop prior to the end of the runway 12.

As illustrated in FIG. 13 the indicator means 43 are supported on masts 44 at the front corners of the carriage assembly 14. These masts may also support the communication means 48 which communicate with sensors on the aircraft or portions of the aircraft to assist in the remote control of the carriage assembly 14 to accomplish a safe capture of the aircraft 10.

FIG. 10 illustrates an alternative form of control of the cradle assembly by hydraulic ram assemblies 50 operatively connected between the cradle assembly 18 and the base frame 29 of the carriage assembly 14. The ram assemblies 50 may be remotely controlled to raise and lower the cradle assembly to suit each particular landing sequence, including the rotated landing angle of the aircraft to be captured.

FIG. 11 illustrates the use of an air bag 52 to support the cradle assembly 18 in its elevated attitude. The air bag 52 may be provided with valving means to allow automatic deflation and lowering of the cradle assembly 18 or the deflation valves may be remotely controlled.

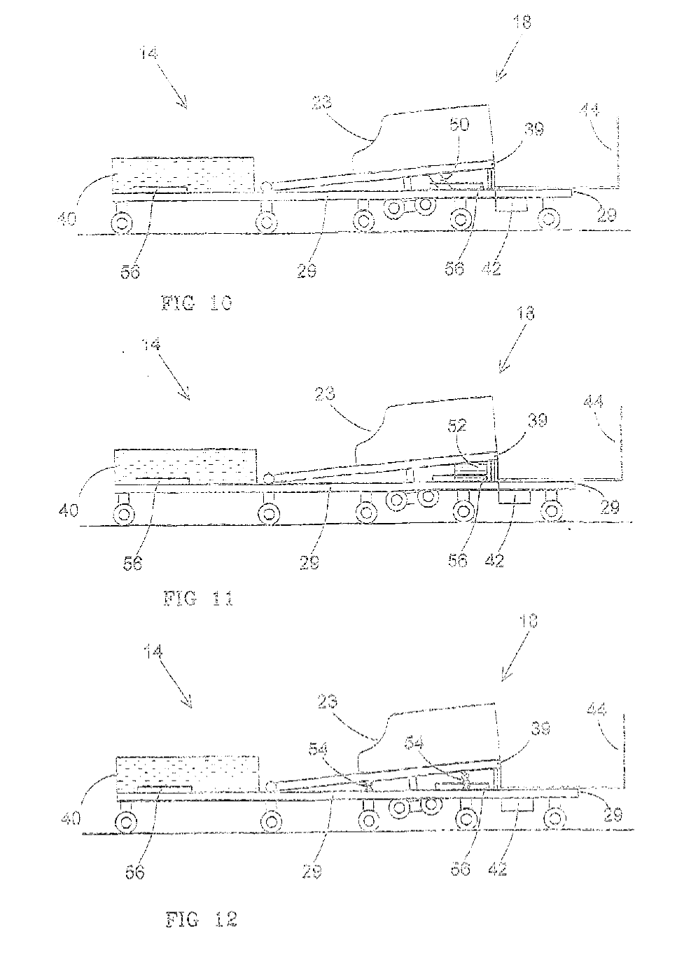

FIG. 12 illustrates an embodiment in which front and rear sets of spring shock absorber units 54 and 55 are utilised to control lowering of a captured aircraft to its disembarking attitude at which the aircraft is captured by the jaws which in turn are locked to the carriage assembly 14 to stably support the aircraft.

Of course a combination of air bags, hydraulic rams and spring and shock absorber units may be utilised to achieve a landing which will not be uncomfortable for the pilots and passengers of an aircraft landed on the carriage assembly, whether it be a commercial, passenger or military aircraft.

In the embodiment illustrated in FIGS. 1 to 8 which utilises the weight of the aircraft to close and/or lock the jaws 15 and 16 and to bring extra wheels 27 into contact with the ground, the operating and control mechanisms are minimised along with the overall weight of the carriage assembly 14. As a result, less power is needed to accelerate the carriage assembly to a landing speed and less braking effort is required to bring the combined unit to a stop.

Also as earthing landed aircraft is a necessity to prevent sparks which could ignite flammable liquids or gases, earthing straps are provided in the jaws 15, 16 which are connected to the undercarriage for earthing in known manner. A separate earth connection may be provided to enable dedicated earthing straps to be connected to the carriage assembly and through it to the supported aircraft. The carriage assembly can also be equipped electronics in order to conduct runway coefficient tests and runway inspections.

It will of course be realised that the above has been given by way of illustrated embodiment of the invention and that all such variations as would be apparent to persons skilled in the art are deemed to fall within the broad scope and ambit of this invention as defined by the following claims.

1. A method of landing an aircraft including:
providing a carriage assembly which may travel along a landing path at the landing speed of the aircraft;
providing braking means capable of decelerating the carriage assembly supporting an aircraft to a manoeuvrable speed within the length of the landing strip;
operatively positioning the carriage assembly for receiving an aircraft at the end of its flight path;
flying the aircraft onto the operatively positioned carriage assembly; and
operating the braking means to reduce the speed of the carriage assembly supporting the aircraft.

2. The method of claim 1, wherein the speed reduction occurs within the length of the landing path.

3. The method of claim 1 or claim 2, wherein the landing path is a regularly used runway at an airport where all necessary landing, control and emergency services are active.

4. The method according to any one of the preceding claims, wherein the carriage assembly is parked ready for use adjacent the runway and preferably beside the runway at a central location on or in-line with the runway, from which parked position the carriage assembly may be readily moved to the touchdown zone of the aircraft to receive the landing aircraft.

5. The method according to any one of the preceding claims, wherein the carriage assembly receives the aircraft in its nose-up landing position at an altitude above its touchdown altitude whereby the aircraft may be united with the carriage assembly.

6. A carriage assembly for use in at least one of the methods described above, and including:
a carriage assembly for capturing a landing aircraft at touchdown, and
braking means for decelerating the carriage assembly and a captured aircraft to a manoeuvrable speed within the length of the landing strip.

7. The carriage assembly according to claim 6, and including drive means for operatively positioning the carriage assembly on the runway for receiving an aircraft at the end of its flight path.

8. The carriage assembly according to claim 6 or claim 7 and including a base assembly supporting a cradle assembly which may receive an aircraft at an altitude above its normal landing altitude relative to the runway and subsequently capturing the aircraft as the cradle assembly is lowered with the aircraft.
